(19) United States
(12) Patent Application Publication
(10) Pub. No.: US 2011/0170550 A1
(43) Pub. Date: Jul. 14, 2011

(54) NETWORK NODE AND LOAD DISTRIBUTION METHOD FOR NETWORK NODE

(76) Inventor: Masanori Takashima, Tokyo (JP)

(21) Appl. No.: 13/120,794

(22) PCT Filed: Sep. 30, 2009
(86) PCT No.: PCT/JP2009/067024

§ 371 Date: Mar. 24, 2011

(30) Foreign Application Priority Data
Oct. 2, 2008 (JP) 2008-257530

(51) Int. Cl. H04L 12/56

(52) U.S. Cl. 370/400

(57) ABSTRACT

A network node includes: a plurality of network modules in which virtual nodes are installed; and a switch module being a starting point of a star connection when the network modules are connected in the star connection. Each network module includes: a physical interface connecting the network module to an outside network; and a network virtualization unit carrying out, with respect to data arriving in the physical interface, a destination search based on keys extracted from information of the data to determine whether the destination is a virtual node installed in a network module that includes the physical interface at which the data arrived or a virtual node installed in a network module that is connected by way of the switch module, and transmitting the data to a virtual node mounted in either network module in accordance with the determination result.

### TECHNICAL FIELD

The present invention relates to a network node configured as a communication apparatus realized by a plurality of network modules having equivalent functions and to a method of distributing load of the network node.

### BACKGROUND ART

A virtual network that is constructed to cover a network serving as an underlay network, and that has a different name space than the underlay network is referred to as an overlay network. The network serving as the underlay network is based on, for example, TCP/IP (Transmission Control Protocol/Internet Protocol) or MPLS (Multi-Protocol Label Switching). A plurality of overlay networks corresponding to a plurality of services can be constructed on an underlay network. Andy et al. disclose that a network technology that does not depend on existing network technology can be used in virtual networks that are constructed by overlay networks ([1] Andy Bavier, Nick Feamster, Mark Huang, Larry Peterson, Jennifer Rexford, “In VINI veritas: realistic and controlled network experimentation,” September 2006, SIGCOMM. '06: Proceedings of the 2006 Conference on Applications, Technologies, Architectures, and Protocols for Computer Communications). This overlay network technology is being used to offer functions or services such as Skype or BitTorrent on the Internet. This type of overlay network technology has enabled, for example, speech communication that surpasses firewalls that was not possible in TCP/IP communications to date. The demand for overlay networks, along with their usefulness, has thus been growing with each year. In addition, Andy Bavier et al. also disclose a method of separating, by virtual machine technology, virtual nodes realized by software and thus accommodate a plurality of virtual networks through the use of a single server [1].

As a method of realizing an overlay network, there exists a technique realized by peer-to-peer communication among a plurality of clients. However, because traffic cannot be optimized in network-based control when peer-to-peer communication is used, the increase in traffic of overlay networks realized by peer-to-peer communications is currently the cause for the waste of band in the network of each communication provider.

In response, JP-A-2008-54214 discloses a technique for realizing network-based optimization of traffic in an overlay network by deploying virtual nodes realized by software in servers on an underlay network.

However, because numbers of overlay networks cannot be processed all at once in a technique, such as described in JP-A-2008-54214, in which virtual nodes realized by software are deployed in each underlay network, the virtual nodes become bottlenecks of the scalability of the overlay network. As a result, the load of network nodes in which virtual nodes are installed must be distributed to eliminate bottlenecks.

A typical method of achieving the load distribution of nodes in a network involves the round-robin method in which access to a single address is distributed to a plurality of nodes. JP-A-2004-110611 discloses a communication apparatus that, by storing access to one specific address from an outside network and converting to the address of a local server when a plurality of servers (local servers) are deployed in a local network, distributes access data among the plurality of servers to distribute the load of the processing of servers. Such a communication apparatus will be hereinbelow referred to as a load distribution apparatus or load balancer.

FIG. 1 shows a system that includes load distribution apparatus 902 and a plurality of network modules 903 connected to load distribution apparatus 902. Network modules 903 are devices used for, for example, servers. In this configuration, the processing performance of the system as a whole can be improved by using load distribution apparatus 902 to distribute server accesses among a plurality of network modules 903. However, load distribution apparatus 902 is connected to an outside network by way of physical interface 901, and this physical interface 901 therefore becomes a bottleneck. Performance in this system is therefore regulated by the transfer performance of load distribution apparatus 902 or physical interface 901, and the transfer performance as a whole therefore peaks despite increasing the number of network modules.

When a network node is constructed by a plurality of servers for establishing overlay networks according to the above-described technique, a plurality of servers can be deployed on the underlay network, a load balancer can be deployed at the preceding stage of the load balancer, and communication addressed to servers can be distributed by means of the load balancer, whereby traffic applied as input to each sever can be distributed and the processing load per server can be reduced. Nevertheless, the problem occurs that when a plurality of server groups communicate with an outside communication apparatus in this configuration, the connection sites with an outside network tend to concentrate at the one point of the load balancer, whereby the traffic concentrates in the load balancer and the transfer performance of the load balancer becomes a bottleneck. In addition, since the result of a control signal processing such as routing or provisioning as a virtual node in a particular server cannot be reflected in the processing of a load balancer in this type of configuration, integrated control cannot be implemented and operation becomes problematic. A load balancer is configured to determine the server to which access is to be distributed and to store the access upon detecting access that matches information that has been set in advance. As a result, when a virtual node implements a dynamic routing protocol (such as STP (Spanning Tree Protocol), OSPF (Open Shortest Path First), and DI-IT (Distributed Hash Table)) or dynamic provisioning and changes a standby state, information of the load balancer that has been set in advance must be dynamically added, altered, or deleted. However, because there is no communication means between a virtual node and a load balancer for transferring this type of information from the virtual node to the load balancer, the result of control signal processing as a virtual node cannot be reflected in the processing of the load balancer.

### SUMMARY OF THE INVENTION

Problem to be Solved by the Invention:

It is an exemplary object of the present invention to, in a single network node that integrates a plurality of network modules as constituent elements each can implement one or a plurality of virtual nodes that can accommodate an overlay network, achieve an increase in the total processing capability and transfer capability in accordance with increase of network modules.

It is another exemplary object of the present invention to implement coordinated control among a plurality of network modules constituting virtual nodes of an overlay network to thus integrate the plurality of network modules and enable management of the plurality of network modules as a single network node, thus facilitating the control and operation of the plurality of network modules.

Means for Solving the Problem:

According to an exemplary aspect of the present invention, a network node comprises: a plurality of network modules in which virtual nodes are installed; and a switch module being a starting point of a star connection when the plurality of network modules are connected in the star connection. Each of the network modules comprises: a physical interface connecting the relevant network module to an outside network; and a network virtualization unit carrying out, with respect to data arriving in the physical interface, a destination search based on keys extracted from information of the data to determine whether the destination is a virtual node installed in the network module that includes the physical interface at which the data arrived or a virtual node installed in a network module that is connected by way of the switch module, and transmitting the data to the virtual node that is installed in either of the network modules in accordance with the determination result.

According to another aspect of the present invention, a load distribution method in a network node including a plurality of network modules in which virtual nodes are installed and a switch module being a starting point of a star connection when the plurality of network modules are connected in the star connection, each of the network modules including a physical interface used in connections with an outside network, includes: carrying out, with respect to data that have arrived in a physical interface, a destination search based on keys extracted from information of the data; determining based on the result of the destination search whether the destination of the data is a virtual node installed in a network module that includes the physical interface at which the data arrived or a virtual node installed in a network module that is connected by way of the switch module; transmitting data to a virtual node that is installed in either network module in accordance with the determination result; and establishing a new virtual node in, of the plurality of network modules, a network module in which load is lightest.

The above-described configuration enables, for example, the implementation of control that is coordinated among a plurality of network modules making up virtual nodes of an overlay network, enables integrating and handling a plurality of network modules as a single network node, and facilitates management and operation as a network node. In addition, increasing network modules within a network node enables, for example, obtaining an improvement in the capabilities of virtual nodes realized by the distribution of processing and an improvement of the total transfer capability realized by increasing the number of interfaces.

### BRIEF DESCRIPTION OF THE DRAWINGS

FIG. 1 is a view showing a system that includes a load balancer (load distribution apparatus);

FIG. 2 is a view describing an outline of a physical network and a plurality of virtual networks accommodated in this physical network;

FIG. 3 is a view showing the configuration of a virtual network realized by virtual nodes and virtual links;

FIG. 4 is a block diagram showing the configuration of a network node;

FIG. 5 is a block diagram showing the connections between functional blocks that process transmission/reception data;

FIG. 6 is a block diagram showing the connections between functional blocks relating to processing of control signals;

FIG. 7 is a view explaining control information of transmission/reception data;

FIG. 8 is a view explaining the lifecycle of a virtual node; and

FIG. 9 is a block diagram showing the configuration of a virtual node interface.

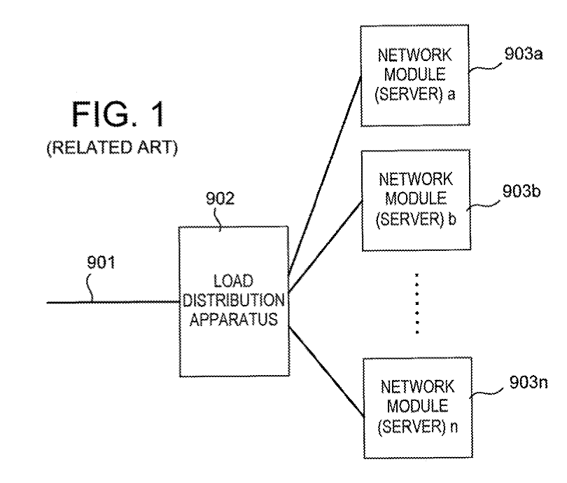

### MODE FOR CARRYING OUT THE INVENTION

An exemplary embodiment of the present invention is next described with reference to the accompanying drawings.

The exemplary embodiment of the present invention described hereinbelow relates to a network node that is constituted as a communication apparatus by a plurality of network modules having equivalent functions and to a load distribution method of this network node. In particular, the exemplary embodiment is directed to the management and control of paths that are coordinated among network modules and tables of the paths for realizing communication of the virtualized virtual nodes that are independently deployed in each of the network modules.

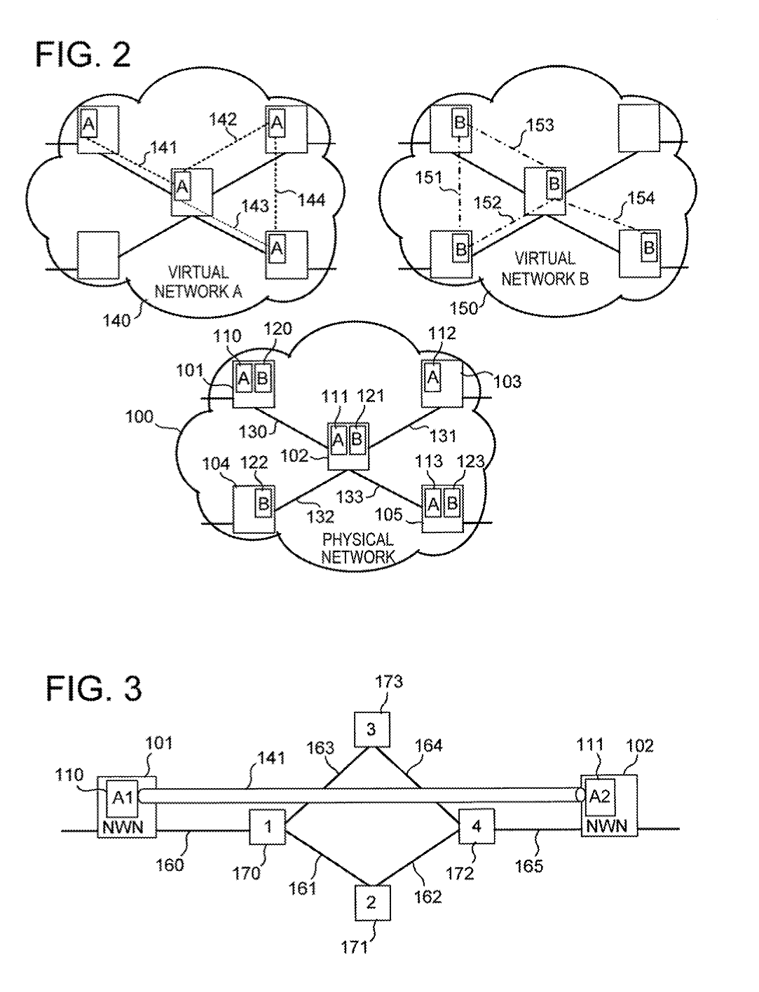

An example of the configuration of a network to which the exemplary embodiment of the present invention can be applied is first described. FIG. 2 shows the basic relations between, for example, physical network. (i.e., underlay network) 100 and a plurality of virtual networks (i.e., overlay networks) 140 and 150 constructed over this physical network.

Network nodes 101 to 105 constructing a virtual network are made up from physical network 100, and virtual nodes 110 to 113 and 120 to 123 are installed on these network nodes. Here, the two virtual networks 140 and 150 are distinguished by “A” and “B,” and virtual nodes 110 to 113 labeled by letter “A” are virtual nodes of the “A” virtual network 140 and virtual nodes 120 to 123 labeled by letter “B” are virtual nodes of the “B” virtual network 150. Virtual nodes of both virtual networks may coexist in the same network node, or only the virtual node of one virtual network may exist. These virtual nodes are connected to each other by virtual links 141 to 144 and 151 to 154 for each virtual network that is an overlay network. Examples of connections that can be used in the virtual links include TCP session or IP/IPSec (Internet Protocol Security) tunnels, MPLS paths, and ATM (Asynchronous Transfer Mode) connections. in physical network 100, network nodes 101 to 105 are connected by, for example, links 130 to 133.

The network nodes and the links between them are not in a one-to-one correspondence with the nodes and links (i.e., physical links) in the physical network. FIG. 3 shows an example of the relation between nodes and links in the virtual network and physical network. In the example shown here, the links between two network nodes 101 and 102 pass by way of a plurality of underlay nodes 170 to 173. Virtual nodes 110 and 111 installed on network nodes 101 and 102 are connected by virtual link 141 to construct a virtual network. Network nodes 101 and 102 and underlay nodes 170 and 172 as well as underlay nodes 170 to 173 are connected by physical links 160 to 165. Underlay nodes 170 to 173 are constituted by typical routers and switches, route computation is carried out by routing protocol of, for example, existing STP or, OSPF, and data are transmitted using transfer protocols such as TCP/IP or Ethernet®, MPLS.

As seen from an underlay network (i.e., a physical network), a virtual network is in a nested form by the connection of virtual node 110 labeled as “A1” and virtual node 111 labeled as “A2” by virtual link 141. By giving a virtual network a name space independent of the underlay network, a virtual network can be constructed that does not depend on the protocol of the underlay network. The use of the independent name space is used as a known technique in an IP-VPN (Virtual Private Network) according to MPLS or an Internet VPN according to IPsec. On the other hand, changing the processing operations of virtual nodes and causing processing of a new network technology in virtual nodes that are connected by a plurality of virtual links enables the application of the new network technology on a virtual network.

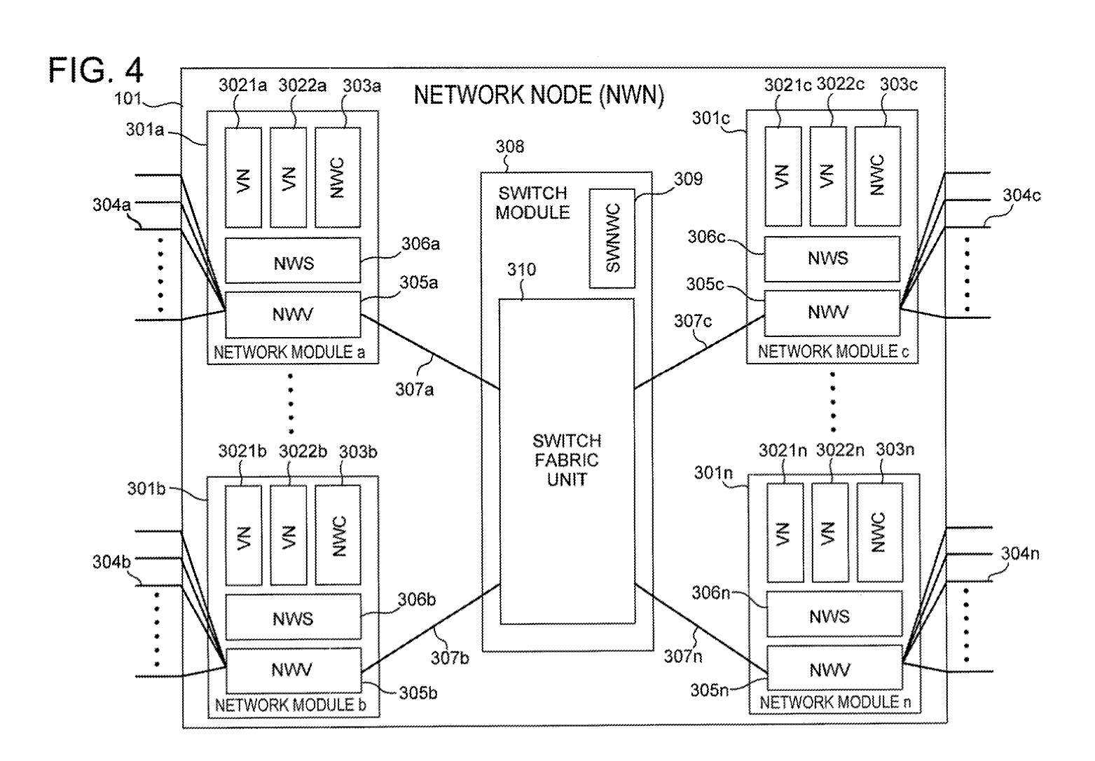

FIG. 4 shows an example of the internal configuration of network node 101 in an exemplary embodiment. Network node 101 is configured as a communication apparatus.

Network node 101 is made up from a plurality of network modules 301a to 301n and switch module 308 interconnecting these network modules 301a to 301n. Each of network modules 301a to 301n is connected to switch module 308 by connections 307a to 307n for data transfer that are provided in a radiating form from switch module 308. Accordingly, switch module 308 is the starting point of the star connections when connecting network modules 301a to 301n in a star connection.

In the following explanation, it will be assumed that reference number 301 is used to show typical network modules without distinguishing among the plurality of network modules. Similarly, reference number 307 is used when indicating a typical connection for data transfer without distinguishing among the plurality of connections.

In network node 101, physical interfaces 304a to 304n are provided in network modules 301a to 301n, respectively. Network modules 301a to 301n can each be connected to an outside network by physical interfaces 304a to 304n. Network modules 301a to 301n all have the same configuration. Network module 301a is provided with: network virtualization unit (NWV) 305a, network stack unit (NWS) 306a, a plurality of virtual node units (VN) 3021a and 3022a, and network control unit (NWC) 303a, and is further provided with previously described physical interface 304a. Similarly, the other network modules 301b to 301n are also provided with: network virtualization units 305b to 305n, network stack units 306b to 306n, virtual node units 3021b to 3021n and 3022b to 3022n, network control units 303b to 303n, and physical interfaces 304b to 304n. A characteristic identifier/number is assigned to each of these functional blocks.

In the following explanation, virtual node units 3021a to 3021n and 3022a to 3022n contained in network modules 301a to 301n are typically represented by reference numbers 3021 and 3022 when the network module in which a virtual node unit is contained is not distinguished. Similarly, network control units 303a to 303n, physical interfaces 304a to 304n, network virtualization units 305a to 305n, and network stack units 306a to 306n are each represented by reference numbers 303, 304, 305, and 306, respectively, when the network modules in which the components are contained are not distinguished.

Network virtualization unit 305 searches and selects the distribution destination of data, which are received in network node 101 from an outside network, from among network stack unit 306 in the same network module 301, virtual node units 3021 and 3022 in the same network module 301, and virtual node units 3021 and 3022 on a different network module 301. Then network virtualization unit 305 transmits the received data to the selected distribution destination. In addition, network virtualization unit 305 searches and selects the distribution destination of data, which are transmitted to an outside network from network node 101, from among physical interface 304 within the same network module 301 and physical interface 304 on a different network module 301 and transmits the transmission data to the selected physical interface. In other words, network virtualization unit 305 has the function of carrying out, with respect to data that have arrived in physical interface 304, a destination search based on a key extracted from information of these data to determine whether the destination is a virtual node that is installed or mounted on the network module that includes the physical interface of arrival or a virtual node that is installed or mounted on a network module that is connected by way of switch module 308, and according to the determination result, transmitting the data to the virtual node that is installed on either of the network modules.

Network stack unit 306 processes transfer protocol in the underlay network. Network stack unit 306, upon receiving control information of transmission/reception data from network virtualization unit 305, in accordance with the received control information, selects one from virtual node units 3021 and 3022 to transmit the data to the selected virtual node unit, or searches for a destination of the transmission/reception data by means of transfer protocol in the underlay network. When a search of destination by means of the transfer protocol in the underlay network is to be carried out, network stack unit 306, by means of the search results, selects one of virtual node units 3021 and 3022 to transmits the data to the selected virtual node unit, or transmits the data to network virtualization unit 305 for transmission to a virtual node on an outside network or another network module 301. Network stack unit 306 further, upon receiving control information of transmission/reception data from virtual node units 3021 and 3022, based on the control information, transmits data to network virtualization unit 305 or searches for the destination of the transmission/reception data by means of transfer protocol in the underlay network to transmit the data to network virtualization unit 305 for transmitting the data to this destination. Network stack unit 306 further terminates the address in the name space of the underlay network.

In the present exemplary embodiment, a plurality of virtual node units 3021 and 3022 are installed in network module 301, but this installation of a plurality of virtual node units on a single network module can be realized by using typical technology such as container technology or virtual machines in related technological fields. These points will be clear to one of ordinary skill in the art. Although two virtual node units are here installed in each network module, the number of virtual node units installed in one network module is not limited to two and may be three or more. Alternatively, a form in which only one virtual node unit is installed in one network module may also be adopted.

Virtual node units 3021 and 3022 process transmission/reception data that are received from network stack unit 306 and further execute termination of the virtual links in the virtual network, processing of communication data that are transmitted on virtual links, and processing of control signals in the virtual network. Here, the processing of communication data includes processing such as termination and transfer. When, as the results of processing of received data in virtual node units 3021 and 3022 or as the result of internal processing such as control signal processing, data must be transmitted, the virtual node units transmit data 601 together with control information 602 to network stack unit 306. The details of control information 602 will be described later.

Network control unit 303 executes processes such as the registration, correction and deletion of various table information in network module 301 and processes control information from each virtual node unit 3021 and 3022. In particular, network control unit 303 acquires setting information relating to information that has an effect on its own network module 301 and maintains tables. Network control unit 303 further exchanges control messages and performs information synchronization relating to information having an effect on other network modules 301 or switch module 308. Network control unit 303 further performs information synchronization based on control messages obtained from other network modules 301 or switch module 308, acquires setting information relating to information that has an effect on its own network module 301 and maintains tables.

Switch module 308 is made up from switch fabric unit 310 and switch network control unit (SWNWC) 309. In the transfer of transmission/reception data, switch fabric unit 310 refers to control information 602 (to be explained below) to choose which network module 301 to transmit transmission/reception data and transmits transmission/reception data to that network module. Switch network control unit 309 carries out maintenance, such as registering, correcting, or deleting, of table information in switch module 308 and exchanges control messages with network modules 301. In particular, switch network control unit 309, in accordance with control information from each network module 301, acquires setting information relating to information that has an effect upon switch module 308 and maintains tables.

Network control unit 303 in network module 301 and switch network control unit 309 in switch module 308 thus function as network control means that, by exchanging control messages with each other, and moreover, by performing maintenance of the contents of various tables, effect synchronization of the network control information between a plurality of network modules 301 and switch module 308. The network control information here described may include information such as network routing information and virtual link information formed based on the processing results of, for example, routing and provisioning in virtual node units.

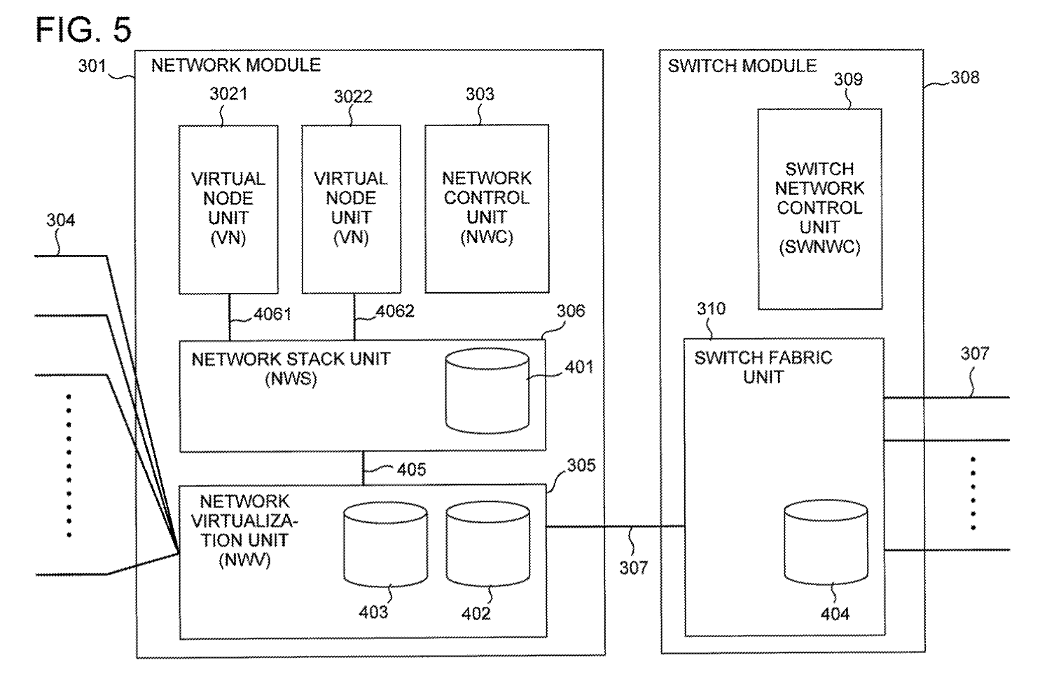

Each component making up the communication paths of transmission/reception data in network node 101 is next described with reference to FIG. 5. FIG. 5 shows the connections between each functional block that directly processes the transmission/reception data in network node 101. The components making up the communication paths of transmission/reception data in network module 301 include: shared transfer table 401 arranged in network stack unit 306; other-module transfer table 402 and virtual node interface transfer table 403 arranged in network virtualization unit 305; connection 405 between network virtualization unit 305 and network stack unit 306; and connections 4061 and 4062 between network stack unit 306 and virtual node units 3021 and 3022. Shared transfer table 401 is used for searching for transfer destinations of transmission/reception data in network stack unit 306 and holds routing information of the underlay network. Other-module transfer table 402 and virtual node interface transfer table 403 are both used for searching for transfer destinations of transmission/reception data in network virtualization unit 305. In particular, other-module transfer table 402 is used for searching for virtual nodes on a network module other than the network module in which this network virtualization unit 305 is provided, whereas virtual node interface transfer table 403 is used for searching for virtual nodes on the network module in which this network virtualization unit 305 is provided. Connections 405, 4061 and 4062 are connections used for the transfer of transmission/reception data. The components constituting the communication routes of transmission/reception data in switch module 308 include: switch transfer table 404 that is provided in switch fabric unit 310 and used for searching for transfer destinations of transmission/reception data in switch fabric unit 310. The communication routes of transmission/reception data are realized by each of these components (i.e., blocks) and connections for data transfer.

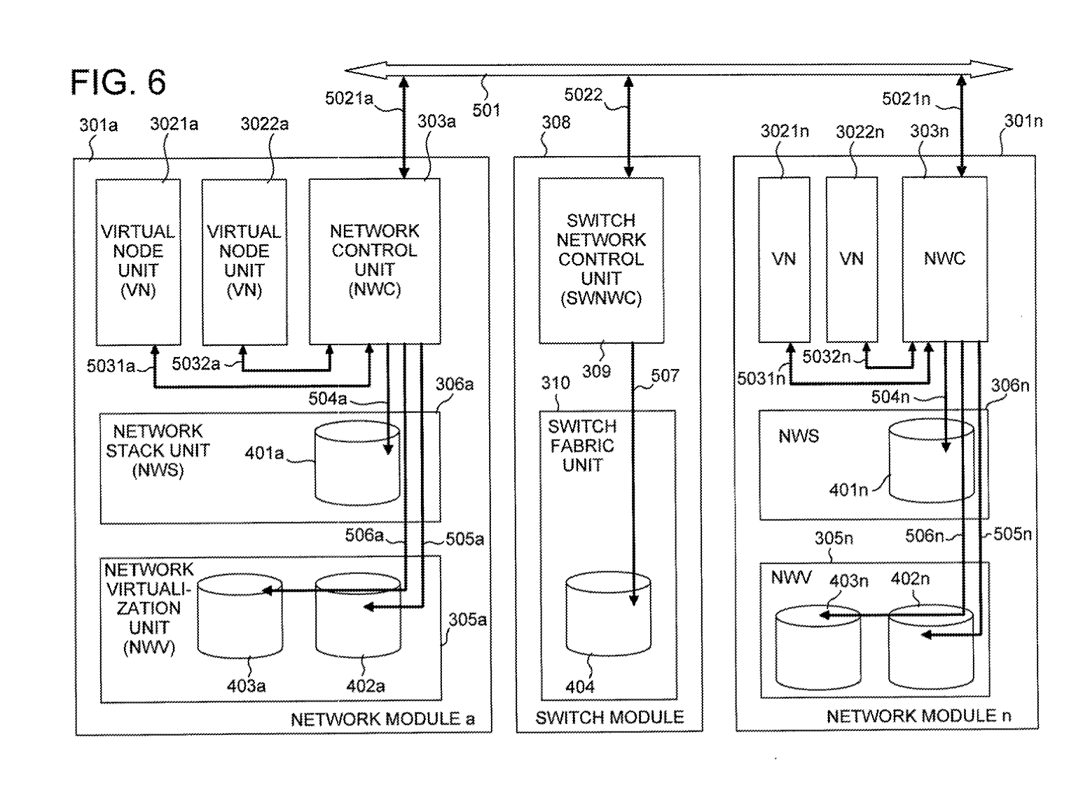

The connection configuration of control signals between the blocks within network node 101 is similarly described with reference to FIG. 6. FIG. 6 shows the connections among the functional blocks relating to processing of control signals in network node 101. The connection configuration for control signals in network module 301 is made up from: connections 5031 and 5032 between network control unit 303 and virtual node units 3021 and 3022; connection 504 between network control unit 303 and shared transmission table 401; connection 505 between network control unit 303 and other-module transmission table 402; and connection 506 between network control unit 303 and virtual node interface transmission table 403. The connection configuration for control signals in switch module 308 is made up from connection 507 between switch network control unit 309 and switch transmission table 404. All of connections 5031, 5032, 504, 505, 506 and 507 are used for the transmission of control signals. The connection configuration of control signals further includes: communication path 501 between network control units for transmitting control messages between the plurality of network modules 301 and switch module 308; connection 5021 between this communication path 501 and network control unit 303 of network module 301; and connection 5022 between communication path 501 and switch network control unit 309 of switch module 308. The connection configuration of control signals is realized by each of these components (i.e., blocks) and connections.

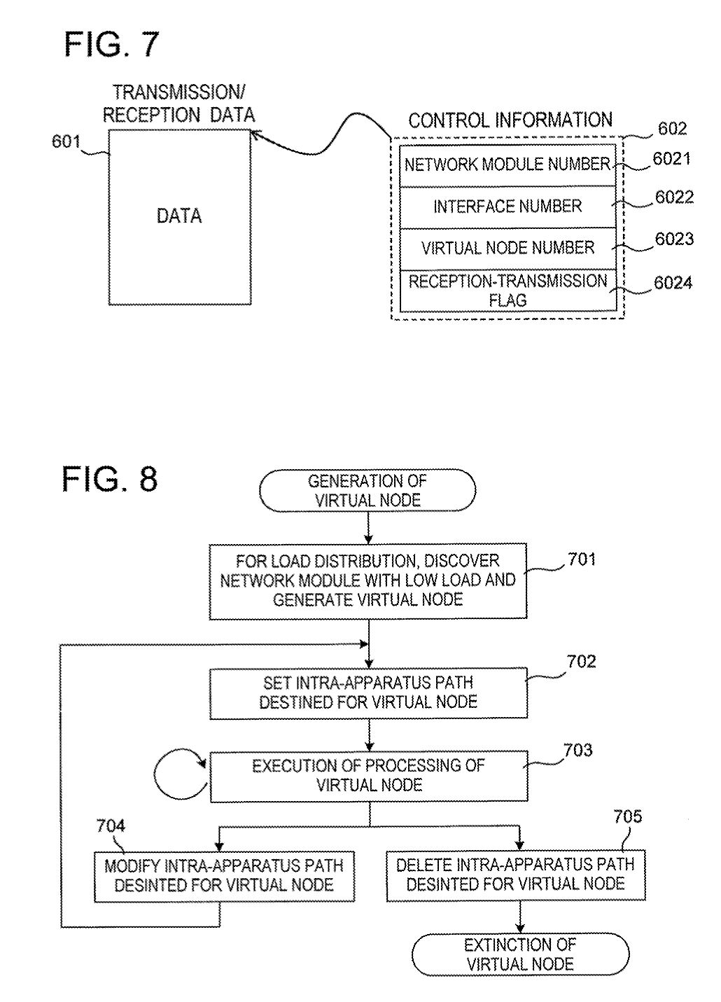

Control information 602 is next described. FIG. 7 shows the relation between transmission/reception data and the control information thereof. To deal with transmission/reception data, network node 101 treats the main body of data that are received and/or transmitted as transmission/reception data 601 and manages each of this type of transmission/reception data 601 and control information 602 for this transmission/reception data in transmission/reception data units. Control information 602 is made up from network module number 6021, interface number 6022, virtual node number 6023, and reception-transmission flag 6024. Control information 602 is created in network virtualization unit 305, network stack unit 306, and virtual node units 3021 and 3022 at the time of receiving and transmitting data 601 and is consulted and rewritten in network virtualization unit 305, network stack unit 306, virtual node units 3021 and 3022, and switch fabric unit 310.

Transmission/reception data 601 are constituted as, for example, IP packets or Ethernet® frames.

When the destination of the data is virtual nodes 3021 and 3022 at the time of data reception, reception-transmission flag 6024 indicates “reception,” the identifier/number of the network module that is the destination is set in network module number 6021, an interface identifier/number unique in network node 101 at the time of reception is set in interface number 6022, and an identifier/number of the virtual node is set in virtual node number 6023. When the destination of data is not set in advance to either of virtual node units 3021 or 3022 at the time of data reception, reception-transmission flag 6024. indicates “reception,” the identifier/number of that network module is set in network module number 6021, an interface identifier/number that is unique in network node 101 at the time of reception is set in interface number 6022, and a special number is set in virtual node number 6023. These data are sent to network stack unit 306 and a transfer process is carried out according to the protocol of the underlay network.

At the time of data transmission, reception-transmission flag 6024 indicates “transmission,” the identifier/number of the network module that is the destination is set in network module number 6021, an interface identifier/number that is unique in network node 101 of the transmission interface is set in interface number 6022, and the virtual node number 6023 is “Don't Care.”

Explanation of Operations:

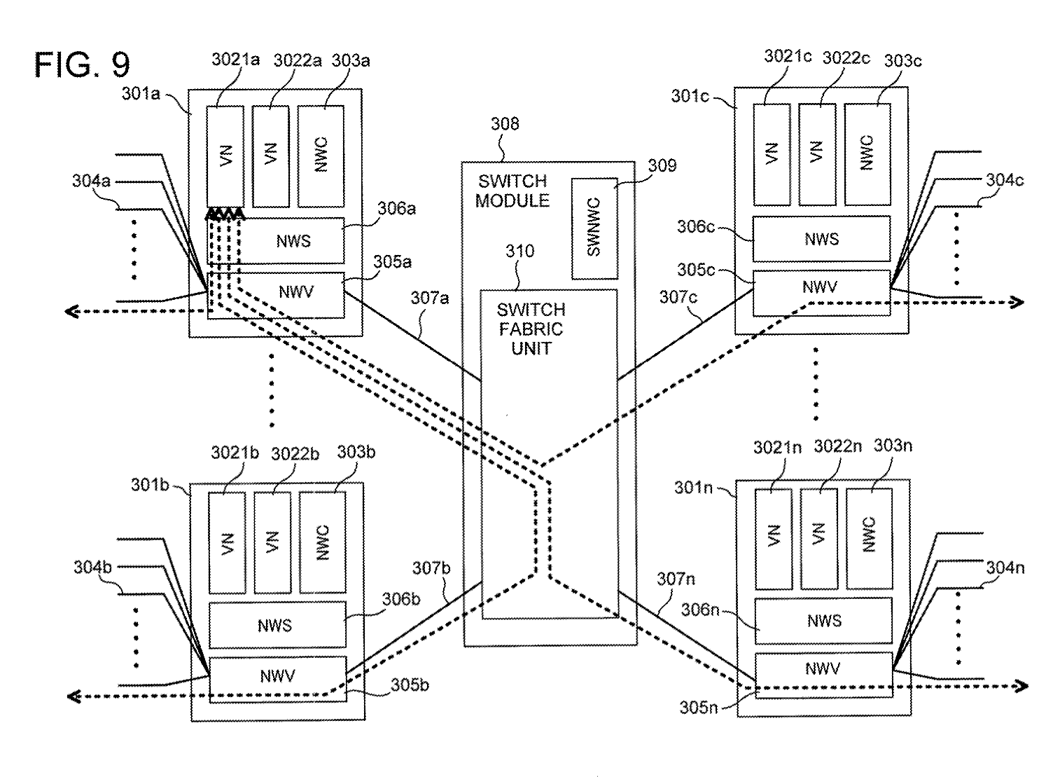

The operations are next described for reducing the processing of each of virtual node units 3021 and 3022 by a load distribution method to improve the performance of network module'301 in the virtual network configuration such as shown in FIG. 3. FIG. 8 shows the lifecycle of a virtual node and FIG. 9 shows the configuration of the interface of the virtual node.

Referring to FIG. 8, in the lifecycle of a virtual node, network module 301 of low load is discovered for distributing load and virtual node units 3021 and 3022 are newly generated in the discovered network module, as shown in Step 701. Regarding the method of discovering a network module of low load, methods can be considered: in which the CPU load states of all network modules 301 in network node 101 are monitored and the network module in which the average load is lowest is selected; in which the traffic volume flowing to each network module 301 is monitored and the network module in which the traffic volume is lowest is selected; or in which these methods are combined. It is here assumed that virtual node units 3021a and 3022a are generated in network module 301a.

An interface path is next set to generated virtual node unit 3021a, in Step 702. Here, the transfer protocol of the underlay network is assumed to be IP (Internet Protocol), and the tunnel protocol constituting the virtual link is assumed to be GRE (Generic Routing Encapsulation). Since the physical interface from which IP traffic is received is typically not specified in this case, path settings must be enabled for data received at all physical interfaces 304a to 304n of all network modules 301a to 301n and virtual node unit 3021a. Accordingly, the path settings of the dotted lines shown in FIG. 9 are necessary. The operations of these path settings are carried out as shown below.

The tunnel protocol (in this case, GRE and IP) and the conditions with the virtual network are first set in virtual node unit 3021a. The virtual network is set as tunnel topology. Since the present exemplary embodiment involves IP traffic, virtual node unit 3021a determines to construct paths with all physical interfaces. Virtual node unit 3021a next reports the path conditions to network control unit 303a in the same network module 301a. In the present example, these path conditions are represented by the dotted lines shown in FIG. 9.

In network module 301a, network control unit 303a next carries out in virtual node interface transmission table 403a the settings for data addressed to virtual node unit 3021a that is accommodated by this network module. In this example, the settings are carried out by registering entries with IP address and GRE Key as keys. Network control unit 303a next transmits path information of virtual node unit 3021a to switch network control unit 309 in switch module 308 and network control units 303b to 303n in other network modules 301b to 301n by way of communication path 501, which is a control bus, between the network control units.

In network modules 301b to 301n, each of network control units 303b to 303n both carries out the settings of other-module transfer tables 402b to 402n and carries out the settings for data addressed to virtual node unit 3021a that is accommodated by network module 301a to other-module transfer tables 403b to 403n. In this example, entries relating to virtual node unit 3021a are registered in other-module transfer tables 403b to 403n with the IP address and GRE Key as keys.

When there are no entries addressed to network module 301a in switch transfer table 404, switch network control unit 309 carries out settings of these entries.

By carrying out such settings, all data that match tunnel protocol (in this example, GRE and IP) addressed to virtual node unit 3021a and that arrive at any physical interface 304 of network node 101 will be transferred to virtual node unit 3021a of network module 301a. Virtual node unit 3021a is thus able to execute processing that corresponds to virtual networks as shown in Step 703 in FIG. 8.

It is here assumed that a change occurs in network module 301 that relates to virtual node unit 3021a. In such a case, a resetting of a path is driven by a new addition, exchange, or deletion of network module 301 in Step 704. At this time, only table entries relating to the relevant network module are amended.

When the termination of a service of virtual node unit 3021a has been decided, the relevant paths are deleted from all table entries of network node 101 and the process of the virtual node unit is halted, in Step 705.

The flow of processes for data at the time of data reception in the present exemplary embodiment is next described. In the following explanation, descriptions such as “[R1]” and “[RA6]” are labels for distinguishing each process in the flow.

The process flow indicated by: [R1]→[R2]→[R3]→[R4a]→[RA5]→[RA6] is a normal process flow when virtual node unit 3021a corresponding to data is installed in network module 301a that has received the data. This process flow is referred to as the first reception process flow.

The process flow indicated by: [R1]→[R2]→[R3]→[R4b]→[RB5c]→[RBC6]→[RBC7]→[RBC8]→[RBC9]→[RBC10] indicates a normal process flow when virtual node unit 3021n corresponding to data is installed in network module 301n that differs from network module 301a that has received data. This process flow is referred to as the second reception process flow.

The process flow indicated by: [R1]→[R2]→[R3]→[R4b]→[RB5d]→[RBD6]→[RBD7] is a normal process flow for data transferred by the transfer protocol of an underlay network. This process flow is referred to as the third reception process flow.

Each process in the first reception process flow is first described. The process of each label in the first reception process flow is shown hereinbelow. The labels are shown below as headings followed by explanations of the processes for the labels.

[R1]: Data are received.

[R2]: Network, virtualization unit 305a generates control information 602 and appends to interface number 6022 the identifier/number of the physical interface at the time the data were received.

[R3]: Network virtualization unit 305a searches virtual node interface transfer table 403a with interface number 6022 and information (such as the destination IP address, the protocol number, and the GRE Key value) contained in data 601 as keys.

[R4a]: When, as the result of the search in process [R3], the data are addressed to virtual node unit 3021a installed in its own network module 301a, network virtualization unit 305a updates network module number 6021 and virtual node number 6023 of control information 602 to its own network module identifier/number and virtual node identifier/number, respectively, and transfers data 601 and control information 602 to network stack unit 306a.

[RA5]: Network stack unit 306a, based on network module number 6021 and virtual node number 6023 of control information 602, transfers data 601 and control information 602 to appropriate virtual node unit 3021a.

[RA6]: Virtual node unit 3021a acquires the physical interface number based on control information 602. Virtual node unit 3021a further terminates the tunnel protocol of received data 601 as a virtual link, acquires communication data in the virtual network, and carries out processing that is determined in advance.

The second reception process flow is next described. Processing from [R1] to [R3] is the same as in the first reception process flow and only the processing following process [R3] is described hereinbelow.

[R4b]: When, as a result of the search in process [R3], a mishit occurs, network virtualization unit 305a uses the same key to search for other-module transfer table 402a.

[RB5c]: When, as a result of the search in process [R4b], the data are addressed to another network module 301n, network virtualization unit 305a updates network module number 6021 of control information 602 to the other-network module identifier/number of the destination and transfers data 601 and control information 602 to switch fabric unit 310.

[RBC6]: Based on network module number 6021 of received control information 602, switch fabric unit 310 searches switch transfer table 404 and transfers the data to network virtualization unit 305n of network module 301n.

[RBC7]: Network virtualization unit 305n searches virtual node interface transfer table 403n with the information (for example, the destination IP address, protocol number, and GRE Key value) contained in data 601 and interface number 6022 as keys.

[RBC8]: When, as a result of the search of process [RBC7], the data are addressed to virtual node unit 3021n installed in its own network module 301n, network virtualization unit 305n updates virtual node number 6023 of control information 602 to the identifier/number of the virtual node and transfers data 601 and control information 602 to network stack unit 306n.

[RBC9]: Network stack unit 306n, based on virtual node number 6023 and network module number 6021 of control information 602, transfers data 601 and control information 602 to the appropriate virtual node unit 3021n.

[RBC10]: Based on control information 602, virtual node unit 3021n acquires the physical interface number. Virtual node unit 3021n further terminates the tunnel protocol of received data 601 as a virtual link, acquires communication data in the virtual network, and carries out predetermined processing.

The third reception processing flow is next described. Processing from [R1] to [R4b] is the same as in the second reception processing flow, and only processing that continues from process [R4b] is described hereinbelow.

[RB5d]: When, as a result of the search of process [R4b], a mishit occurs, network virtualization unit 305a transfers data 601 and control information 602 to network stack unit 306a.

[RBD6]: Due to the fact that virtual node number 6023 of control information 602 has not been set, network stack unit 306a determines that data 601 are communication data of the underlay network, and in addition to carrying out a protocol process upon data 601, searches shared transfer table 401 a with header information (for example, IP header information) contained in data 601 and interface number 6022 of control information 602 as keys. The header information corresponds to transfer protocol of the underlay network.

[RBD7]: For data 601 for which the destination has been resolved as a result of the search of process [RBD6], network stack unit 306n rewrites transmission-reception flag 6024 of control information 602 from “reception” to “transmission,” updates network module number 6021 and interface number 6022 to the identifier/number of the network module including the transmission interface and the transmission interface identifier/number, respectively, and transfers to network virtualization. unit 305a.

The processing flow for data at the time of data transmission in the present exemplary embodiment is next described. In the following explanation, the notations “[T1]” and “[TA5]” are labels for distinguishing each process in the flow.

The process flow indicated by [T1]→[T2]→[T3a]→[TA4]→[TA5] is a process flow when physical interface 304 of the output destination can be resolved in virtual node unit 3021a. This is referred to as the first transmission process flow.

The process flow indicated by [T1]→[T2]→[T3b]→[TB5]→[TB6] is a process flow for a case in which data are transmitted to physical interface 304 of the output destination by causing resolution of the transfer destination by the transfer protocol of the underlay network because the output destination physical interface 304 cannot be resolved in virtual node unit 3021a. This is referred to as the second transmission process flow.

Each process in the first transmission process flow is first described. The processes for each label in the first transmission process are as shown below. The labels are shown below as headings followed by explanations of the processes for the labels.

[T1]: Based on the result of resolving the transmission destination of data 601, virtual node unit 3021a rewrites transmission-reception flag 6024 of control information 602 from “reception” to “transmission,” updates network module number 6021, interface number 6022, and virtual node number 6023 to the identifier/number of the network module containing the transmission interface, the transmission interface identifier/number, and the virtual node identifier/number, respectively, and transfers data 601 to network stack unit 306a.

[T2]: Network stack unit 306a verifies interface number 6022 of control information 602 of received data 601.

[T3a]: When a valid value is set in interface number 6022 in process [T2], network stack unit 306a transfers data 601 and control information 602 to network virtualization unit 305a.

[TA4]: In network virtualization unit 305a, data 601 and control information 602 are transferred based on network module number 6021 and interface number 6022. If data 601 are addressed to the physical interface of another network module 301n, then the procedure of process [RBC6] is used to transfer data 601 and control information 602 to the other network module 301n. When transmission-reception flag 6024 is “transmission” and network module number 6021 and interface number 6022 indicate physical interfaces 304a to 304n of their own network modules 301a to 301n, network virtualization units 305a to 305n supply data 601 as output to these physical interfaces.

[TA5]: The data are transmitted.

The second transmission process flow is next described. The processes of [T1] and [T2] are the same as in the first transmission process flow, and only the processes following process [T2] are described hereinbelow.

[T3b]: When interface number 6022 is not set in process [T2], network stack unit 306a determines that data 601 are communication data of the underlay network, and in addition to carrying out a protocol process upon data 601, searches shared transfer table 401a with header information (for example, IP header information) contained in data 601 and interface number 6022 of control information 602 as keys. The header information corresponds to transfer protocol of the underlay network.

[TB4]: For data 601 for which the destination has been resolved as a result of the search in process [T3b], network stack unit 306a updates network module number 6021 and interface number 6022 of control information 602 to the identifier/number of the network module containing the transmission interface and the transmission interface identifier/number, respectively, and transfers to network virtualization unit 305a.

[TB5]: Based on network module number 6021 and interface number 6022, network virtualization unit 305a transfers data 601 and control information 602. If data 601 is addressed to a physical interface of another network module 301n, network virtualization unit 305a uses the procedure of process [RBC6] to transfer data 601 and control information 602 to the other network module 301n. When transmission-reception flag 6024 is “transmission” and when network module number 6021 and interface number 6022 indicate physical interfaces 304a to 304n of their own network modules 301a to 301n, network virtualization units 305a to 305n supply data 601 to these physical interfaces.

[TB6]: Data transmission is carried out.

In the present exemplary embodiment, routing information of the network protocol in the underlay network is registered in shared transfer table 401 in network stack unit 306 of network module 301. The same information is registered in synchronization in shared transfer tables 401 of all network modules 301. In the configuration of the present exemplary embodiment, the components that are distributed and arranged among network modules 301 for the purpose of load distribution are virtual node units 3021 and 3022. As a result, regarding transmission/reception data other than data addressed to virtual node units, synchronization among shared transfer tables 401 can be easily achieved by extracting, as the physical interface that is the output destination, the same information regardless of which shared transfer table 401 of network stack unit 306 of network module 301 is searched. Even if the physical interface belongs to a different network module 301 at the time of transmission, data 601 are transferred within network node 101 based on the information of control information 602 by means of network virtualization unit 305 and switch fabric unit 310, whereby network stack unit 306 need not alter the settings of shared transfer table 401 while keeping aware of individual units and may register the same information uniformly in shared transfer tables 401 in network node 101.

According to the present exemplary embodiment, deploying network virtualization units 305 on a subordinate layer of network stack units 306 that process the protocol of an existing underlay network enables the use of network virtualization units 305 without greatly altering existing network stack units 306. This capability is possible because, according to this type of configuration, transmission/reception data that cannot be processed at all in existing network stack units 306 can be distributed by network virtualization units 305 in advance and network stack units 306 can be bypassed. In addition, the deployment of network virtualization units 305 on a subordinate layer of network stack units 306 enables the load distribution of network modules in which virtual node units 3021 and 3022 are installed. This capability is possible because, even if addresses of the same identifiers/numbers are used in network stack units 306 of the plurality of network modules 301 in network node 101, transmission/reception data can be distributed in network virtualization units 305 by, for example, information such as TCP port numbers or UDP port numbers that is of finer granularity than addresses.

Essentially, network node 101 as described hereinabove includes:

one or a plurality of virtual node units;

network virtualization unit 305 on network module 301 that carries out a determination based on table information that has been set in advance to specify, from among one or a plurality of virtual node units of a plurality of network modules 301 in network node 101, the virtual node unit that processes transmission/reception data;

switch fabric unit 310 on switch module 308 that, based on table information that has been set in advance, specifies, from among a plurality of network modules 301 in network node 101, network module 301 that includes output paths and virtual node units 3021 and 3022 that process reception data;

network control unit 303 of network module 301 and switch network control unit 309 of switch module 308 that carry out maintenance such as the registration, alteration, and deletion of the table information;

communication paths 501 that transmit control messages that exchange information between network control unit 303 of network module 301 and switch network control unit 309 of switch module 308 for sharing the previously described table information among a plurality of network modules 301 and switch module 308; and

means for notifying network control unit 303 of network control information that is determined in virtual node units to reflect that information in the network.

The network control information is, for example, provisioning information such as routing, topology, and QoS (Quality of Service) in the virtual network. The notification means is made up from, for example, control signal connections 5031 and 5032.

Configuring network node 101 in this way enables both an improvement in the capabilities of virtual node units 3021 and 3022 due to the distribution of processing and an improvement of the total transfer capability due to the increase in the number of interfaces with each increase of network modules 301. In addition, with respect to the processing of transmission/reception data, processing can be carried out in each of the plurality of network modules 301 arranged and distributed in network node 101 in accordance with the instructions that reflect the results of processing control signals in virtual node units 3021 and 3022 distributed within network node 101. If necessary, transmission/reception data can be transmitted to virtual nodes on network modules 301 arranged and distributed within network node 101.

The above-described exemplary embodiments are open to still further modifications as shown below.

### EXAMPLE 1

By deploying access lists in network control unit 303 and switch network control unit 309, table entries or the like that must not been set by access from virtual node units 3021 and 3022 can be filtered. In this way, mutual isolation of virtual networks can be realized.

### EXAMPLE 2

Network control unit 303 can transfer control messages from other network modules 301 to virtual node units 3021 and 3022, thereby enabling coordinated operations between independent virtual networks or enabling the emphasis of processes that are working in virtual node units 3021 and 3022. For example, OSPF operating in virtual node unit 3021a on network module 301a and BGP (Border Gateway Protocol) operating in virtual node unit 3022 on network module 301b can thus be linked.

### EXAMPLE 3

When transmission-reception flag 6024 of control information 602 is set to “transmission” and when conditions are met such that the information of interface number 6022 is made ineffective by, for example, storing the value “F” in all entries and that an effective value is applied as input to virtual node number 6023, a search of virtual node interface transfer table 403 by network virtualization unit 305 allows data that have been processed once in a particular network module 301 to be again processed in different network module 301. In this way, a multistage connection of virtual node units becomes possible, an improvement can be achieved in the transfer capability by pipeline processing in a virtual network, and more complex processing for one item of data becomes possible by a network having the same transfer capability.

### EXAMPLE 4

The field of network module number 6021 of control information 602 can be divided between a network module number for transmission and a network module number for reception, the field of interface number 6022 can be divided between an interface number for transmission and an interface number for reception, and the field of virtual node number 6023 can be divided between a virtual node number for transmission and a virtual node number for reception. When each field is divided between transmission use and reception use in this way and control information for transmission and control information for reception are divided and stored, rewriting of control information 602 becomes unnecessary, and because previous information is not lost when implementing multistage connection as shown in Example 3, a reception interface number can continue to be used to carry out a filter process in a later stage.

### EXAMPLE 5

Performing settings with respect to routing protocol packets of an underlay network in the same procedure as the procedure for setting the paths of virtual node units allows the collection of protocol packets in virtual node units 3021 and 3022, whereby the routing protocol of the underlay network is processed in virtual node units 3021 and 3022 and path information that should be stored in shared transfer table 404 of network stack unit 306 can be created. In this configuration, another module need not be prepared for the routing protocol process of the underlay network.

### EXAMPLE 6

When the underlay network is a layer-2 network, in setting paths of virtual links in virtual node units 3021 and 3022 of network node 101, paths may be set in only network module 301 that accommodates the specific physical interface 304 directly accommodating links with adjacent network node 102. In this configuration, the table entries of all network modules 301 need not be consumed to set paths.

Although the present invention has been described above with reference to an exemplary embodiment and examples, the present invention is not limited to the above-described exemplary embodiment and examples. The constitution and details of the present invention are open to various modifications within the scope of the present invention that will be understood by one of ordinary skill in the art.

This application claims priority based on Japanese Patent Application No. 2008-257530 for which application was submitted on Oct. 2, 2008, and incorporates all of the disclosures of that application by reference.

References:

### Patent Literature(s):

JP-A-2008-054214

JP-A-2004-110611

### Non-Patent Literature(s):

[1] Andy Bavier, Nick Feamster, Mark Huang, Larry Peterson, Jennifer Rexford, “In VINI veritas: realistic and controlled network experimentation,” September 2006, SIGCOMM '06: Proceedings of the 2006 Conference on Applications, Technologies, Architectures, and Protocols for Computer Communications.

### EXPLANATION OF REFERENCE NUMBERS

100 physical network

101 network node

140, 150 virtual networks

301a to 301n network modules

3021a to 3021n, 3022a to 3022n virtual node units

303 network control unit

304 physical interface

305 network virtualization unit

306 network stack unit

308 switch module

309 switch network control unit

310 switch fabric unit

401 shared transfer table

402 other-module transfer table

403 virtual node interface transfer table

404 switch transfer table

1-11. (canceled)

12. A network node comprising:
a plurality of network modules in which virtual nodes are installed;
a switch module connecting said plurality of network modules; and
a network virtualization unit carrying out a destination search based on keys extracted from information of received data and transmitting said data to a virtual node installed on either network node in accordance with result of said destination search.

13. The network node as set forth in claim 12, wherein:
said network node modules are connected in a star connection, said switching module being a starting point of said star connection;
each of said network modules includes said network virtualization unit and a physical interface, said physical interface connecting the relevant network module to an outside network; and
said network virtualization unit extract said key from data that have arrived in said physical interface, carries out said destination search to determine whether destination is a virtual node installed on the network module that includes the physical interface at which the data arrived or a virtual node installed on a network module that is connected by way of said switch module, and in accordance with result of said determination, transmits said data to a virtual node that is installed on either network module.

14. The network node as set forth in claim 12, wherein:
each of said network modules is includes a network stack unit processing transfer protocol in an underlay network;
said network stack unit includes a shared transfer table holding routing information of said underlay network and searches said shared transfer table to acquire routing information of said underlay network; and
information synchronized in all said network modules is stored in said shared transfer table.

15. The network node as set forth in claim 13, wherein said physical interface and said virtual node are connected by paths in said network modules to bypass processing of protocol stack of the underlay network.

16. The network node as set forth in claim 13, further comprising a network control means that implements information synchronization of information among all said network modules and said switch module in said network node by way of control messages, said information being generated based on result of processing of control signals carried out in said virtual nodes.

17. The network node as set forth in claim 16, wherein said information generated is virtual link information and network routing information constructed based on result of processing of control signals for routing and provisioning.

18. The network node as set forth in claim 12, wherein:
said network virtualization unit includes a virtual node interface transfer table for searching for said virtual node on said network module that includes the relevant network virtualization unit; and
said network virtualization unit, to transmit within the network node communication data addressed to a virtual node, searches said virtual node interface transfer table based on key information extracted from the communication data to discover communication data addressed to a virtual node on the relevant network module.

19. The network node as set forth in claim 12, wherein:
said network virtualization unit includes an other-module transfer table for searching for said virtual node on a network module other than said network module that includes the relevant network virtualization unit; and
said network virtualization unit, to transfer within the network node communication data addressed to a virtual node, searches said other-module transfer table based on key information extracted from the communication data to discover communication data addressed to a virtual node on the other network module.

20. The network node as set forth in claim 12, wherein each of said network modules includes a plurality of virtual nodes.

21. A load distribution method in a network node including a plurality of network modules in which virtual nodes are installed and a switch module being a starting point of a star connection when said plurality of network modules are connected in the star connection, each of the network modules including a physical interface used in connection with an outside network, the load distribution method including:
carrying out, with respect to data arriving in said physical interface, a destination search based on keys extracted from information of the data;
determining based on result of said destination search whether destination of the data is a virtual node installed in the network module that includes the physical interface at which the data arrived or a virtual node installed in a network module that is connected by way of said switch module;
transmitting said data to a virtual node that is installed in either network module in accordance with said determination result; and
establishing a new virtual node in, of said plurality of network modules, the network module in which load is lightest.

22. The method as set forth in claim 21, wherein a plurality of said new virtual nodes are established.

23. A load distribution method in the network node as set forth in claim 12, wherein, when a new virtual node is established in any of said network modules, the virtual node is established in a network module in which load is lightest.

24. The method set forth in claim 23, wherein:
said network node modules are connected in a star connection, said switching module being a starting point of said star connection;
each of said network modules includes said network virtualization unit and a physical interface, said physical interface connecting the relevant network module to an outside network; and
said network virtualization unit extract said key from data that have arrived in said physical interface, carries out said destination search to determine whether destination is a virtual node installed on the network module that includes the physical interface at which the data arrived or a virtual node installed on a network module that is connected by way of said switch module, and in accordance with result of said determination, transmits said data to a virtual node that is installed on either network module.

25. The network node as set forth in claim 13, wherein:
each of said network modules is includes a network stack unit processing transfer protocol in an underlay network;
said network stack unit includes a shared transfer table holding routing information of said underlay network and searches said shared transfer table to acquire routing information of said underlay network; and
information synchronized in all said network modules is stored in said shared transfer table.

26. The network node as set forth in claim 13, wherein:
said network virtualization unit includes a virtual node interface transfer table for searching for said virtual node on said network module that includes the relevant network virtualization unit; and
said network virtualization unit, to transmit within the network node communication data addressed to a virtual node, searches said virtual node interface transfer table based on key information extracted from the communication data to discover communication data addressed to a virtual node on the relevant network module.

27. The network node as set forth in claim 13, wherein:
said network virtualization unit includes an other-module transfer table for searching for said virtual node on a network module other than said network module that includes the relevant network virtualization unit; and
said network virtualization unit, to transfer within the network node communication data addressed to a virtual node, searches said other-module transfer table based on key information extracted from the communication data to discover communication data addressed to a virtual node on the other network module.

28. The network node as set forth in claim 13, wherein each of said network modules includes a plurality of virtual nodes.
